(19) United States
(12) Patent Application Publication
(10) Pub. No.: US 2003/0033186 A1
(43) Pub. Date: Feb. 13, 2003

(54) Method and system for determining a profitability of medical-technical apparatus

(76) Inventors: Rainer Kuth, Herzogenaurach (DE); Walter Rupprecht, Herzogenaurach (DE)

Correspondence Address: SCHIFF HARDIN & WAITE, 6600 SEARS TOWER, 233 S WACKER DR, CHICAGO, IL, 60606-6473, US

(21) Appl. No.: 10/202,809

(22) Filed: Jul. 25, 2002

(30) Foreign Application Priority Data
Jul. 25, 2001 (DE) 10136238.2

(51) Int. Cl. G06F 17/60

(52) U.S. Cl. 705/8; 705/400

(57) ABSTRACT

In a method and apparatus for determining the economic feasibility for an operator to acquire a further medical-technical apparatus, or a replacement of an existing medical-technical apparatus, an analysis device has access to data representing usage of said existing medical-technical apparatus, data characterizing a remuneration of the operator from the usage of the existing medical-technical apparatus, and data representing operational costs of the operator. The analysis device determines a profitability of the existing medical-technical apparatus and dependent on that profitability, together with the aforementioned data, determines the profitability of acquiring the further device, or the replacement device.

### BACKGROUND OF THE INVENTION

1. Field of the Invention

The present invention is directed to a method and to a system for determining whether an acquisition of a further medical-technical apparatus or a replacement of an existing medical-technical apparatus is economically feasible for an operator of the existing medical-technical apparatus.

2. Description of the Prior Art

The economic feasibility of medical-technical apparatuses, particularly radiological systems, is dependent on many factors that are currently not easily discernable for an operator or a supplier of the medical-technical apparatus or for a creditor of the operator. When the operator of a medical-technical apparatus would like to acquire a further and, in particular, expensive medical-technical apparatus, the creditor who provides the operator with credit for the acquisition of the further medical-technical apparatus must, for example, rely on imprecise estimates of the potential profitability of the further medical-technical apparatus. The creditor therefore sets a correspondingly high risk margin when extending the credit.

Suppliers of medical-technical apparatuses are sometimes compelled, for example, to enter into a buy-back obligation in the sales contract of the medical-technical apparatus if the operation of the medical-technical apparatus should prove unprofitable for the operator. Under certain circumstances, the operator of the medical-technical apparatus also takes on a high entrepreneurial and, possibly, personal risk in the acquisition of the medical-technical apparatus. In all of these cases, it would thus be desirable to determine the potential profitability of the replacement of an existing apparatus or the acquisition of a further medical-technical apparatus in a simple and fast way.

### SUMMARY OF THE INVENTION

An object of the present invention to provide a method that creates prerequisites for ascertaining in a simple way whether the acquisition or the replacement of a medical-technical apparatus is economically feasible. Another object of the invention is to provide a suitable system with which it can be determined in a simple way whether the acquisition or replacement of a medical-technical apparatus is economically feasible.

This object is achieved in accordance with the invention in a method for determining whether the acquisition of a further medical-technical apparatus or the replacement of an existing medical-technical apparatus is economically feasible for an operator of the existing medical-technical apparatus, including the steps of automatically determining first data describing utilization of the existing medical-technical apparatus during the course of utilization thereof, automatically transmitting the first data to a central data bank, determining second data that describe remuneration of the operator on the basis of the utilization of the existing medical-technical apparatus, determining third data that represent operational costs of the operator, based on the first, second and third data, determining the profitability of the existing medical-technical apparatus with an analysis device allocated to the central data bank, and based on the first, second and third data and on the profitability of the existing medical-technical apparatus, determining the likely profitability of the further medical-technical apparatus, or of the replacement of the existing medical-technical apparatus, with an analysis device allocated to the central data bank.

Inventively, thus, the profitability of the existing medical-technical apparatus of the operator is determined on the basis of the first, second and third data. The first data describe the utilization of the first medical-technical apparatus. The utilization of, for example, a radiological scanner is, for example, its time of usage or a number and type of examinations that are undertaken with the radiological scanner. The second data reflect the remuneration of the utilization of the medical-technical apparatus. In the case of a radiological scanner, for example, this can be the remuneration by health insurers for exposures produced with the radiological scanner. However, the second data also can include a remuneration for a consultation or diagnosis that ensues in conjunction with the examination of the radiological scanner. The third data cover the operational costs of the operator. These costs are incurred, for example, for maintenance of the radiological scanner. These costs also include rent for a treatment room in which the radiological scanner is located. Further operational costs are, for example, the salary for an operator of the radiological scanner, etc.

On the basis of this profitability, thus, a decision is made in accordance with the invention as to whether the acquisition of a further medical-technical apparatus is economically meaningful at all or whether the existing medical-technical apparatus should be replaced by a new medical-technical apparatus. The profitability of the existing medical-technical apparatus or its replacement, or the profitability of the further medical-technical apparatus, can be implemented in an especially practical way according to an embodiment of the invention wherein the first, second and third data are transmitted to a central data bank and the profitability of the existing medical-technical apparatus and the potential profitability of the further medical-technical apparatus, or the profitability of replacement of the existing medical-technical apparatus, is/are automatically determined with an analysis device allocated to the data bank. The data bank and the analysis device allocated to the data bank make it possible to determine the potential profitability of the replacement or of the acquisition of the further medical-technical apparatus from the large amount of first, second and third data.

The potential profitability is especially efficiently determined since the first data are automatically determined by the first medical-technical apparatus. A modern radiological scanner has, for example, a control computer that suitably controls the radiological scanner during an exposure with the radiological scanner and prepares a measurement log. This measurement log can at least serve as a basis for the first data.

According to an embodiment of the invention, the third data can, in particular, be a detail about personnel costs, interest costs, deduction for wear (DfW) and/or overhead expenses of the operator.

The potential profitability, further, can be determined in further detail when the tax burden of the operator and/or data representing potential patients for the operator and/or medical referrers of patients in the coverage area of the operator are taken into consideration in the determination of the potential profitability of the further medical-technical apparatus or of the replacement for the existing medical-technical apparatus according to preferred versions of the invention. According to one embodiment of the invention, the representing potential patients can include patient classes, a regional purchasing power profile and/or a proportion of private patients.

According to a preferred embodiment of the invention, future applications that can be implemented with the further medical-technical apparatus or the replacement for the existing medical-technical apparatus are taken into consideration in the determination of the potential profitability of the further medical-technical apparatus or of the replacement for the existing medical-technical apparatus. It is usually relatively wealthy private patients who are often more receptive particularly to new and especially expensive applications.

Taking the presence of competitors into consideration in the determination of the potential profitability of the further medical-technical apparatus or of the replacement for the existing medical-technical apparatus is also provided according to one version of the invention.

According to another embodiment of the invention, the existing medical-technical apparatus, the further medical-technical apparatus and/or the replacement is a magnetic resonance apparatus, a computed tomography apparatus, an X-ray apparatus, an ultrasound apparatus and/or a lithotriptor.

The second object is achieved in accordance with the invention in a system for determining whether an acquisition of a further medical-technical apparatus or replacement of an existing medical-technical apparatus is economically feasible for an operator of the existing medical-technical apparatus, having a central data bank that can be connected to a communication network, the existing medical-technical apparatus, which is configured such that it automatically determines first data describing its utilization and communicates the first data to the central data bank via the communication network, and an analysis device allocated to the central data bank that, based on the first data, and based on second data stored in the central data bank that describe remuneration of the operator from the utilization of the first medical-technical apparatus, and based on third data stored in the data bank that cover operational costs of the operator, determines the profitability of the existing medical-technical apparatus, and, based on the first, second and third data and on the profitability of the existing medical-technical apparatus, determines a potential profitability of the further medical-technical apparatus, or of the replacement for the existing medical-technical apparatus.

### DESCRIPTION OF THE DRAWINGS

FIG. 1 schematically illustrates the inventive system.

FIG. 2 shows a measurement log of a magnetic resonance apparatus of the type generated and used in the inventive method and system.

FIG. 3 is a flowchart illustrating the inventive method.

### DESCRIPTION OF THE PREFERRED EMBODIMENTS

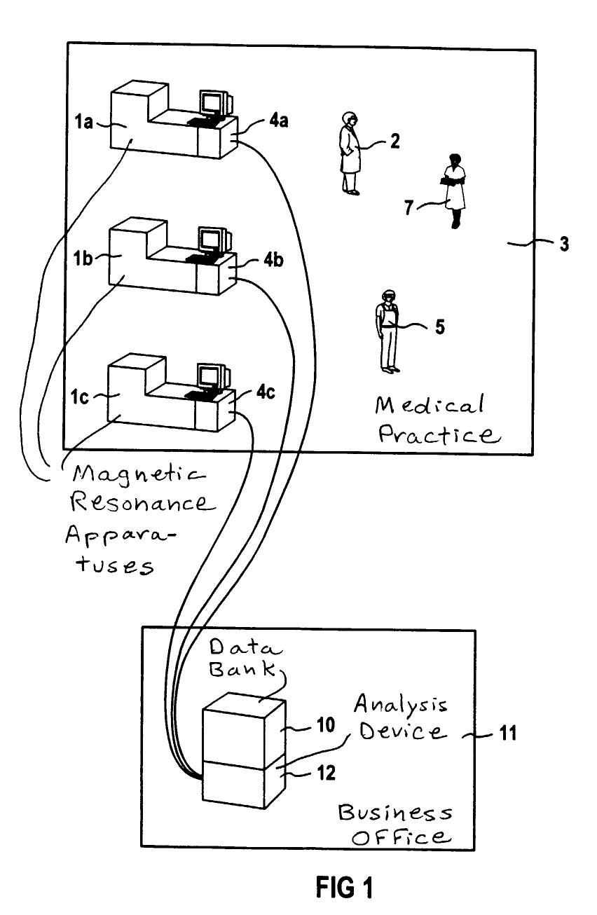

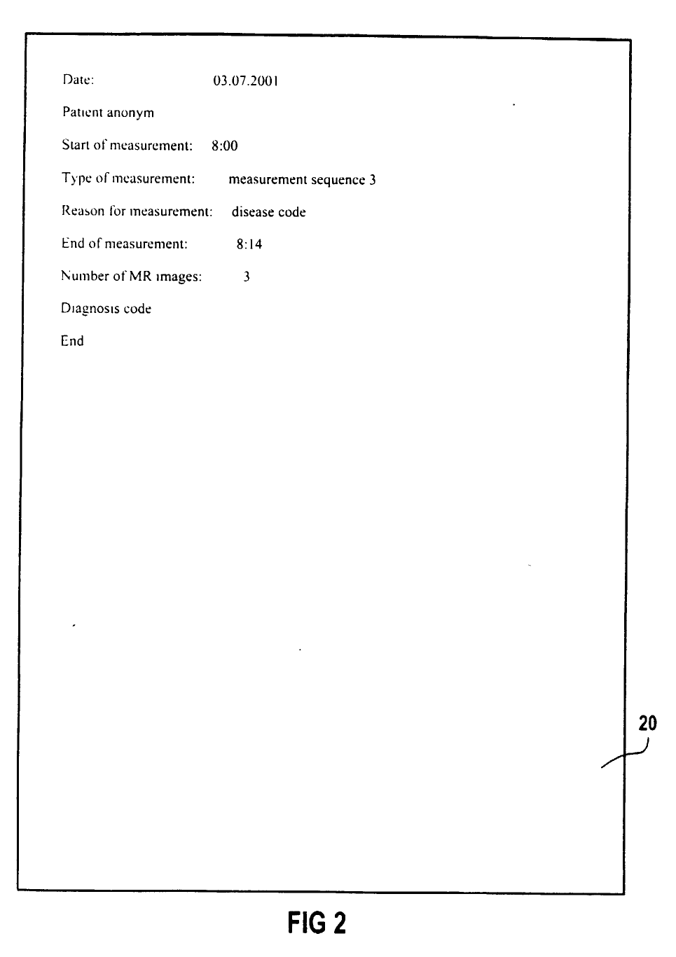

FIG. 1 shows a radiologist 2 in a medical practice 3 to which a number of magnetic resonance apparatuses 1a, 1b and 1c belong. The magnetic resonance apparatuses 1a, 1b and 1c in the exemplary embodiment respectively include computers 4a, 4b and 4c connected to the Internet that control the respective magnetic resonance apparatuses 1a, 1b and 1c in a known way during the examination of a patient and respectively prepare a measurement log during the examination. FIG. 2 shows an example of a measurement log 20 that was produced by the computer 4a of the magnetic resonance apparatus la during an examination of a patient in the present exemplary embodiment.

The measurement log 20 was produced in the following way:

Before the radiologist 2 examines the patient 5 with the magnetic resonance apparatus 1a, the radiologist 2 registers the patient 5 with the computer 4a by entering the personal particulars of the patient 5 into the computer 4a. If the personal particulars are already stored in the computer 4a, the radiologist 2 fetches them. Subsequently, the radiologist 2 selects a measurement sequence suitable for the examination of the patient 5, so that the magnetic resonance apparatus produces an image dataset of the patient 5 in a well-known way. Subsequently, the computer 4a of the magnetic resonance apparatus 1a uses the image dataset 1a to construct MR images in a well-known way which are used by the radiologist 2 to prepare a diagnosis for the patient 5.

The computer 4a automatically produces the measurement log 20 shown in FIG. 2 during the measurement exposure. The measurement log 20 in the present exemplary embodiment includes the times of day at which the examination of the patient 5 with the magnetic resonance apparatus 1a begins and ends, the type of measurement, a code that reflects the reason for the examination, the identity of the patient 5 in encrypted form and the number of reconstructed MR images.

In the exemplary embodiment, the measurement log 20 also includes a code allocated to the diagnosis for the patient 5 that the radiologist 2 enters into the computer 4a after preparing the diagnosis.

Subsequently, the computer 4a automatically communicates the measurement log 20 shown in FIG. 2 to a data bank connected to the Internet that is located in a business office 11 of the manufacturer of the magnetic resonance apparatuses 1a, 1b and 1c.

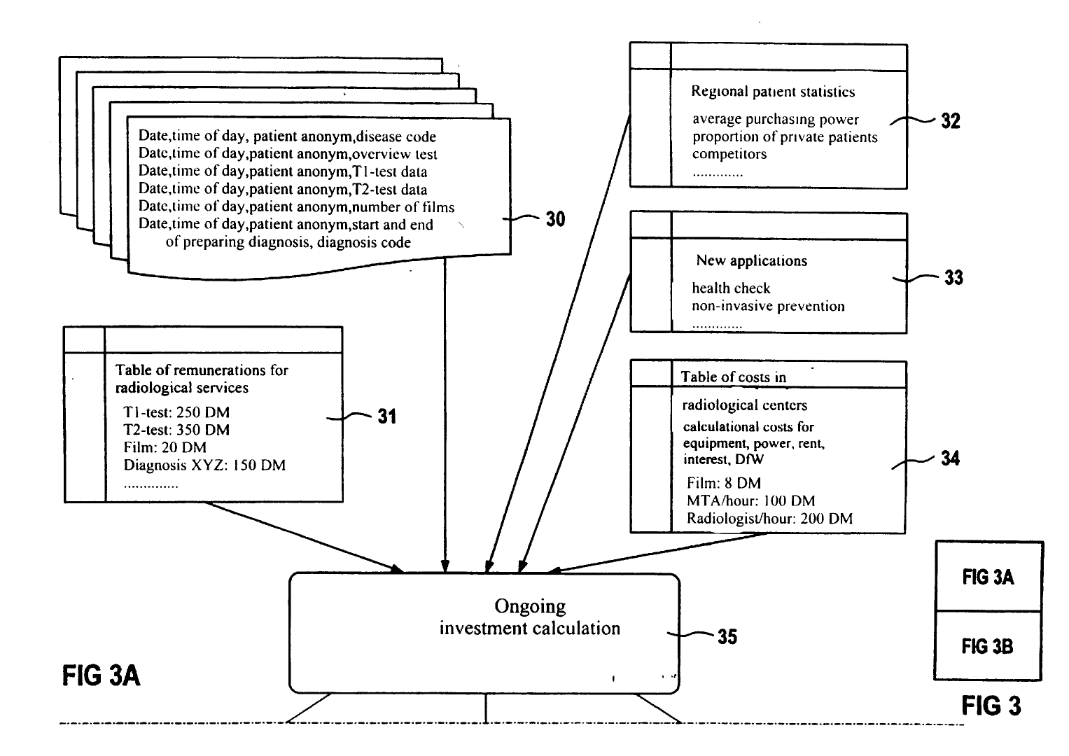

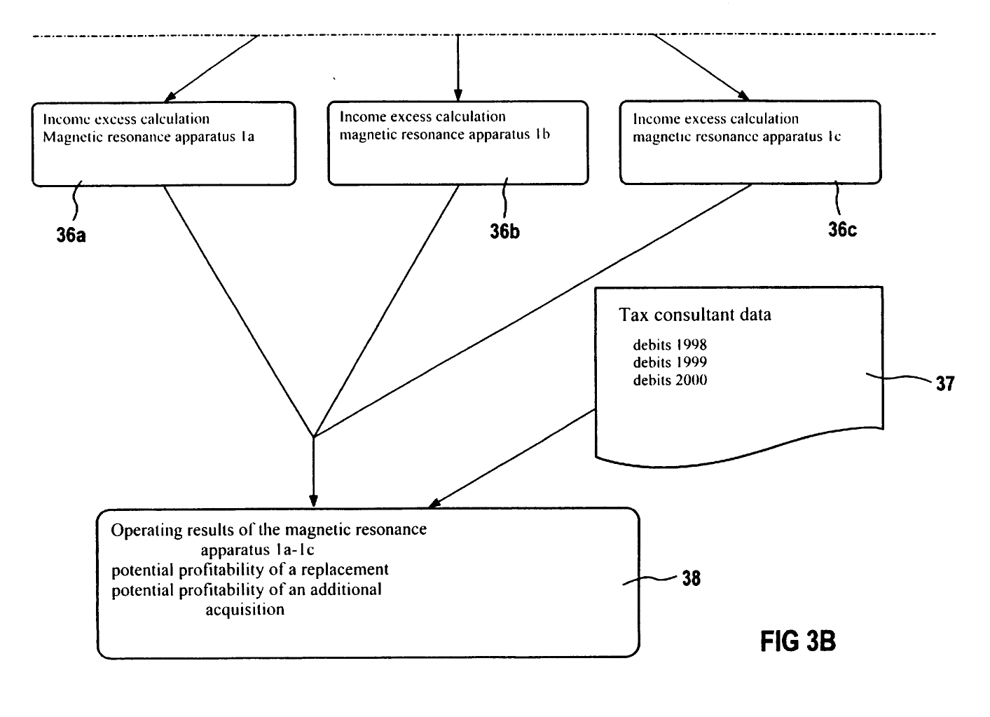

In addition to the measurement log 20, the computer 4a of the magnetic resonance apparatus 1a communicates further measurement logs that are allocated to other patients (not shown in FIG. 1). The computers 4b and 4c of the magnetic resonance apparatus 1b and 1c likewise prepare measurement logs during examinations implemented with them, containing details similar to those of the measurement log 20. These measurement logs are likewise transmitted to the data bank 10. The measurement logs produced by the computers 4a, 4b and 4c of the magnetic resonance apparatus 1a, 1b and 1c are referenced 30 in FIG. 3.

In the exemplary embodiment, a table 31 schematically shown in FIG. 3, patient statistics compilation 32, a list 33 and a cost table 34 also are stored in the data bank 10.

The table 31 includes information about the remuneration of the radiologist 2 on the basis of the services the radiologist has provided. This information includes the remuneration for the examinations performed with the magnetic resonance apparatus 1a, 1b or 1c, costs for the production of MR images produced with the magnetic resonance apparatus 1a, 1b or 1c, remuneration for a diagnosis prepared on the basis of the examination, etc.

The information stored in the patient statistics compilation 32 include average purchasing power, the proportion of private patients and the number of further radiologists in the coverage area of the radiologist 2.

The list 33 includes details about new applications for a magnetic resonance apparatus. These, for example, are newly produced health checks or new, non-invasive preliminary examinations that can be implemented with a magnetic resonance apparatus.

The cost table 34 includes details about operational costs that the radiologist 2 incurs due to the operation of the magnetic resonance apparatus 1a, 1b or 1c. These costs include costs for an employee 7 of the radiologist 2, power costs, interest, rent, etc.

On the basis of the data in the measurement logs 30, in the table 31, the patient statistics compilation 32, the list 33 and the cost table 34, an analysis device 12 allocated to the data bank 10 uses a suitable computer program to calculate an ongoing investment reckoning 35 of the magnetic resonance apparatus 1a, 1b and 1c from which the computer program respectively determines respective income excess reckonings 36a, 36b, 36c of the magnetic resonance apparatuses 1a, 1b and 1c before taxes.

The computer program stored in the analysis device 12 subsequently applies with tax data of past years that are stored in the data bank 10 in a list 37 to the income excess reckonings 36a, 36b and 36c. On the basis of this operation, the computer program stored in the analysis device 12 subsequently determines the current operating results (profitabilities) 38 of each of the magnetic resonance apparatuses 1a, 1b and 1c. On the basis of the current operating result 38 and, in particular, taking the details stored in the table 31, in the patient statistics 32, in the list 33 and in the cost table 34 into consideration, the computer program stored in the analysis device 12 determines the potential profitability of a replacement for one of the magnetic resonance apparatus 1a, 1b or 1c. The computer program also determines the potential profitability of a further magnetic resonance apparatus that the radiologist 2 may acquire in addition to the magnetic resonance apparatus 1a, 1b and 1c.

The plurality of three magnetic resonance apparatus 1a, 1b and 1c is only cited by way of example. The inventive method can also be applied when the radiologist 2 has one, two or more than three magnetic resonance apparatus.

As noted above, the magnetic resonance apparatuses 1a, 1b and 1c respectively have computers 41, 4b and 4c connected to the Internet. The inventive method also can be used, however, when the computers of the magnetic resonance apparatus are not connected to the Internet. Data that describe the utilization of the magnetic resonance apparatus 1a, 1b and 1c need not necessarily be compiled in a measurement log 20. Transmission of the measurement log 30 via the Internet is likewise merely optional.

The inventive method also can be employed for calculating the profitability of additional options of the magnetic resonance apparatus 1a, 1b or 1c.

The inventive method also can be applied to other medical-technical apparatuses such as, in particular, computed tomography systems, lithotriptors, ultrasound apparatuses and/or X-ray apparatuses.

The measurement log 20, the measurement logs 30, the table 31, the patient statistics compilation 32, the list 33 and the cost table 34 are, shown in the illustrated format merely as examples.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for determining economic feasibility for acquiring a further medical-technical apparatus or replacing an existing medical-technical apparatus by an operator of said existing medical-technical apparatus comprising the steps of:
during utilization of said existing medical-technical apparatus, automatically acquiring first data describing said utilization;
automatically transmitting said first data to a central databank;
determining second data describing remuneration of said operator from said utilization of said existing medical-technical apparatus;
determining third data representing operational costs of said operator for operating said existing medical-technical apparatus;
storing said second and third data at said central databank together with said first data and accessing said first, second and third data in said central databank with an analysis device and, in said analysis device, determining a profitability of said existing medical technical apparatus dependent on said first, second and third data; and
in said analysis device, based on said first, second and third data and based on said profitability, determining a profitability for another medical-technical apparatus to be operated by said operator, selected from the group consisting of a further medical-technical apparatus and a replacement of said existing medical-technical apparatus.

2. A method as claimed in claim 1 comprising employing data selected from the group consisting of data representing personnel costs, data representing interest costs, data representing a deduction for wear, and data representing overhead expenses of said operator, as said third data.

3. A method as claimed in claim 1 comprising determining said profitability of said another medical-technical apparatus taking a tax burden of said operator into account.

4. A method as claimed in claim 1 comprising taking data into consideration for determining said profitability of said another medical-technical apparatus selected from the group consisting of data representing potential additional patients for said operator and data representing medical referrers of patients in a coverage area of said operator.

5. A method as claimed in claim 1 comprising determining said profitability of said another medical-technical apparatus dependent on data representing potential additional patients of said operator, selected from the group consisting of patient classification, a regional purchasing power profile in a region in which said operator is located, and a proportion of private patients available in a region in which said operator is located.

6. A method as claimed in claim 1 comprising determining said profitability of said another medical-technical apparatus dependent on future applications which are implementable using said another medical-technical apparatus.

7. A method as claimed in claim 1 comprising determining said profitability of said another medical-technical apparatus dependent on competitors of said operator in a region served by said operator.

8. A method as claimed in claim 1 wherein at least one of said existing medical-technical apparatus, said further medical-technical apparatus and said another medical-technical apparatus is selected from the group consisting of magnetic resonance apparatuses, computed tomography systems, X-ray apparatuses, ultrasound apparatuses, and lithotriptors.

9. A system for determining economic feasibility of acquisition of a further medical-technical apparatus or replacement of an existing medical-technical apparatus for an operator of said existing medical-technical apparatus, comprising:
a central databank adapted for connection to a communication network;
an existing medical-technical apparatus located at an operator and configured to automatically determine first data during usage of said existing medical-technical apparatus describing said usage, and communicating said first data to said central databank via said communication network;
said central databank also having stored therein second data describing a remuneration of said operator from said usage of said existing medical-technical apparatus, and having third data stored therein characterizing operational costs of said operator for operating said existing medical-technical apparatus; and
an analysis device having access to said central databank for determining a profitability of said existing medical-technical apparatus dependent on said first, second and third data and for determining, dependent on said profitability of said existing medical-technical apparatus and dependent on said first, second and third data, a potential profitability of another medical-technical apparatus to be operated by said operator, selected from the group consisting of a further medical-technical apparatus and a replacement for said existing medical-technical apparatus.

10. A method for determining economic feasibility for acquiring a further medical-technical apparatus or replacing an existing medical-technical apparatus by an operator of said existing medical-technical apparatus comprising the steps of:
during utilization of said existing medical-technical apparatus, automatically acquiring first data describing said utilization;
determining second data describing remuneration of said operator from said utilization of said existing medical-technical apparatus;
determining third data representing operational costs of said operator for operating said existing medical-technical apparatus;
storing said second and third data at said central databank together with said first data and accessing said first, second and third data in said central databank with an analysis device and, in said analysis device, determining a profitability of said existing medical technical apparatus dependent on said first, second and third data; and
in said analysis device, based on said first, second and third data and based on said profitability, determining a profitability for another medical-technical apparatus to be operated by said operator, selected from the group consisting of a further medical-technical apparatus and a replacement of said existing medical-technical apparatus.

11. A method as claimed in claim 10 comprising employing data selected from the group consisting of data representing personnel costs, data representing interest costs, data representing a deduction for wear, and data representing overhead expenses of said operator, as said third data.

12. A method as claimed in claim 10 comprising determining said profitability of said another medical-technical apparatus taking a tax burden of said operator into account.

13. A method as claimed in claim 10 comprising taking data into consideration for determining said profitability of said another medical-technical apparatus selected from the group consisting of data representing potential additional patients for said operator and data representing medical referrers of patients in a coverage area of said operator.

14. A method as claimed in claim 10 comprising determining said profitability of said another medical-technical apparatus dependent on data representing potential additional patients of said operator, selected from the group consisting of patient classification, a regional purchasing power profile in a region in which said operator is located, and a proportion of private patients available in a region in which said operator is located.

15. A method as claimed in claim 10 comprising determining said profitability of said another medical-technical apparatus dependent on future applications which are implementable using said another medical-technical apparatus.

16. A method as claimed in claim 10 comprising determining said profitability of said another medical-technical apparatus dependent on competitors of said operator in a region served by said operator.

17. A method as claimed in claim 10 wherein at least one of said existing medical-technical apparatus, said further medical-technical apparatus and said another medical-technical apparatus is selected from the group consisting of magnetic resonance apparatuses, computed tomography systems, X-ray apparatuses, ultrasound apparatuses, and lithotriptors.
